(19) United States
(12) Patent Application Publication
(10) Pub. No.: US 2016/0183559 A1
(43) Pub. Date: Jun. 30, 2016

(54) DIETARY COMPOSITIONS FOR RUMINANTS AND CONTAINERS FOR STORING AND DISPENSING SAME

(71) Applicant: BENEMILK OY, Raisio (FI)

(72) Inventors: James Edward NOCEK, Auburn, NY (US); Merja Birgitta HOLMA, Raisio (FI); Jayesh Ramesh BELLARE, Worli, Mumbai (IN); Feng WAN, Issaquah, WA (US); Timothy Martin LONDERGAN, Seattle, WA (US)

(73) Assignee: BENEMILK OY, Raisio (FI)

(21) Appl. No.: 14/909,122

(22) PCT Filed: Jul. 30, 2013
(86) PCT No.: PCT/US13/52644

§ 371 Date: Jan. 31, 2016

(51) Int. Cl. A23K 1/02; A23K 1/16

(52) U.S. Cl. CPC A23K 1/164; A23K 1/1643; A23K 1/1646; A23K 1/1603; A23K 1/1634; A23K 1/175; A23K 1/1813

(57) ABSTRACT

Feed containers configured to store and dispense dietary compositions for ruminants are disclosed. The dietary compositions may include a fatty acid component, at least one feed ingredient, and water. The fatty acid component may include less than about 10% by weight of unsaturated fatty acid. The feed ingredient may be selected from a carbohydrate, an amino acid, an amino acid derivative, a vitamin, a trace element, a mineral, a glucogenic precursor, or an antioxidant. The feed containers may include a lick tank, a storage container, a trough, a bucket, a pail, or the like. The feed containers may be configured to measure and/or regulate the consumption of the dietary composition stored therein by the ruminants.

### BACKGROUND

Increasing production and fat content of milk obtained from lactating ruminants has been a major goal for dairy farmers. Additional milk production per ruminant is beneficial because it results in a higher yield, thereby increasing profits. Increased milk fat is desirable because it has a higher economic value and can be used in highly desirable food products, such as cheese, yogurt, and the like.

### SUMMARY

In one aspect, feed containers for storing and/or dispensing a dietary composition are provided. In an embodiment, a feeding container may have a dietary composition disposed therein, where the dietary composition comprises at least one saturated fatty acid component and at least one carrier component.

In another aspect, methods of increasing fat content in milk are provided. In an embodiment, a method of increasing fat content in milk may include providing a dietary composition disposed in a feed container to a ruminant for ingestion of the dietary composition. The dietary composition may comprise at least one saturated fatty acid component and at least one carrier component.

In a further aspect, methods for preparing containerized dairy compositions are provided. In an embodiment, a method of preparing a containerized dietary composition may include providing a dietary composition comprising at least one saturated fatty acid component and at least one carrier component, and disposing the dietary composition in a feed container to form a containerized dietary composition.

### BRIEF DESCRIPTION OF THE DRAWINGS

FIG. 1 depicts an illustrative feed container according to an embodiment.

FIGS. 2A and 2B depict flow diagrams of alternative methods of preparing a dietary composition for ruminants according to various embodiments.

FIG. 3 depicts a flow diagram of a method of preparing a dietary composition for ruminants according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below.

A “ruminant” is generally a suborder of mammal with a multiple chamber stomach that gives the animal the ability to digest cellulose-based food by softening it within a first chamber (rumen) of the stomach and to regurgitate the semi-digested mass to be chewed again by the ruminant for digestion in one or more other chambers of the stomach. Examples of ruminants include, but are not limited to, lactating animals such as cattle, goats and sheep. Cattle may include dairy cows, which are generally animals of the species Bos taurus. The milk produced by ruminants is widely used in a variety of dairy-based products. For instance, dairy cows are of considerable commercial significance for the production of milk and processed dairy products such as, for example, yogurt, cheese, whey, and ice cream.

“Silage” refers to a feed that includes chopped green forage, such as, for example, grass, legumes, and field corn. The silage is placed in a structure or a container that is designed to exclude air. The silage is then fermented in the structure or container, thereby retarding spoilage. Silage can have a water content of about 60% to about 80% by weight.

The present disclosure relates generally to dietary compositions that can be fed to ruminants for purposes of affecting milk production in the ruminant. Particularly, the dietary compositions described herein may be fed to a ruminant to increase the amount of milk produced by the ruminant (the “milk yield”) and/or to increase the fat content of the milk produced by the ruminant, as described in greater detail herein. Compositions described herein may be in various forms, such as a liquid form, including liquid suspensions, emulsions, slurries, and/or the like, a solid form, a substantially solid form, a semi-solid form, or any combination thereof.

The dietary compositions may be the main diet of a ruminant or may be a dietary supplement. For instance, pasture-fed or pasture-raised ruminants may require additional dietary supplements in order to meet their dietary requirements, particularly when lactating. Ad libitum feeding, in which the quantity and frequency of feed consumption is the free choice or substantially the free choice of the ruminant, is a challenge because some ruminants may consume too little or too much of certain nutrients. Accordingly, feed containers as described herein may provide a regulated feed source configured to manage the amount of a dietary composition ingested by a ruminant.

When a ruminant consumes feed, the fat in the feed is modified by the rumen to provide a milk fat profile that is different from the profile of fat in the feed. All fats which are not completely inert in the rumen may decrease rumen digestibility of the feed material. Milk composition and fat quality can be influenced by the ruminant's diet. For example, oil feeding can have negative effects on both rumen function and milk formation. As a result of oil feeding, the milk protein concentration is lowered, the fat concentration is decreased, and the proportion of trans fatty acids is increased. These have been connected especially to an increase in harmful low-density lipoprotein (LDL) cholesterol and to a decrease in beneficial high-density lipoprotein (HDL) cholesterol in human blood when the milk is consumed. In addition, the properties of the milk fat during industrial milk processing are weakened. A high level of polyunsaturated fatty acids in milk can also cause taste defects and preservation problems. A typical fatty acid composition of milk fat may be more than about 70% saturated fatty acids and a total amount of trans fatty acids may vary in the range of about 3% to about 10%. When vegetable oil is added into the feed, the proportion of trans fatty acids may rise to more than about 10%.

One solution to diminishing the detrimental effect of oil and fat is to prevent triglyceride fat hydrolysis. Fat hydrolysis can be decreased, for example, by protecting fats with formaldehyde treated casein. Another alternative is to make insoluble fatty acid calcium salts whereby hydrogenation in rumen can be avoided. However, fatty acid salts have a pungent taste, which can limit their usability in feeds and can result in decreased feed intake.

Accordingly, the ruminant feed product described herein may include a fatty acid component that includes at least about 70% to about 99% palmitic acid. Not wanting to be limited by theory, the dietary composition described herein fed to a ruminant using a feeding container as described herein may allow for the transfer of palmitic acid from the feed via the digestive tract into the blood circulation of a ruminant. This improves the energy efficiency of milk production of the ruminant. When the utilization of energy becomes more efficient, the milk production increases and the concentrations of protein and/or fat in the milk may rise. In particular, the dietary compositions disclosed herein may enhance fat synthesis in the mammary gland by bringing milk fat components to the cell and, therefore, the energy consuming synthesis in the mammary gland may not be necessary. As a result, glucose can be used more efficiently for lactose production and milk production may increase. The milk protein content may rise because there may be no need to produce glucose from amino acids. In addition, the ruminant may not lose weight at the beginning of the lactation period, thereby improving the fertility of the ruminant.

In the various embodiments described herein, the dietary compositions may include at least one fatty acid component, at least one feed ingredient, and a carrier component, such as water or a suspension in water. The fatty acid component may be primarily saturated fatty acid (particularly palmitic acid) and may contain little or no unsaturated trans fatty acid, as described in greater detail herein. The fatty acid component may be at least about 30% to about 50% by weight of the liquid composition, the water at least about 25% to about 55% by weight of the liquid composition, and the feed ingredient at least about 9% to about 45% by weight of the liquid composition.

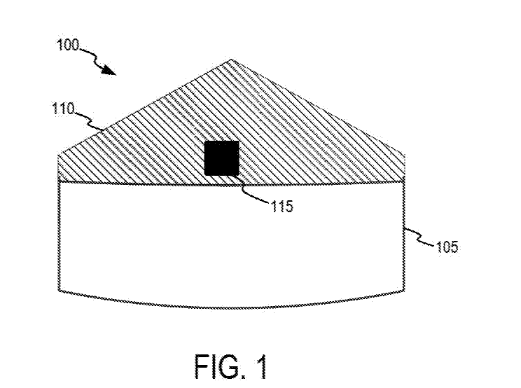

The described technology generally relates to feed containers configured to store and/or dispense dietary compositions described according to some embodiments. The feed containers may be arranged in a pasture, barn, or other location accessible by ruminants. FIG. 1 depicts an illustrative feed container according to an embodiment. As shown in FIG. 1, a feed container 100 may include a container body 105 configured to store at least one dietary composition, such as the dietary compositions described according to some embodiments herein. The feed container may optionally include a cover 110, such as a removable cover configured to enclose the container body 105 and any dietary compositions enclosed therein. The cover 110 may be affixed to the container body 105 such that it may not be removed or may not be easily removed by a ruminant. For example, the cover 110 may be bolted to the container body 105 through a centrally located assembly, may include a lip configured to connect with a flange or overhang arranged around the perimeter of the top portion of the container body, or the like, or a combination thereof. One or more openings 115 may be arranged within the cover 110 to allow the ruminant to access the dietary composition disposed within the container body 105. In an embodiment, the cover 110 may be configured to rotate about the container body 105 to allow more than one ruminant to move the cover such that the ruminant has access to one of the one or more openings 115.

The container body 105 and the cover 110 may be formed from various materials, such as a metal, a metal alloy, various polymer materials, including polyethylene and derivatives thereof, or any combination thereof. The feed container 100 may be configured to hold various quantities of the dietary composition. According to some embodiments, the container 100 may be configured to hold about 16 gallons (about 61 liters), about 50 gallons (about 189 liters), about 125 gallons (about 473 liters), about 250 gallons (about 946 liters), about 2000 liters, or values or ranges between any two of these values (including endpoints). Although the illustrative feed container 100 depicted in FIG. 1 is or is similar to a “lick tank” container, embodiments are not so limited. Any type of container that may operate according to some embodiments is contemplated herein. For instance, the feed container 100 may include a stock tank, a watering tank, a trough, a bucket, a pail, or the like. The feed container 100 may be used for pasture-fed or pasture-raised ruminants and may be used for solid and/or liquid dietary compositions.

The type of feed given to ruminants may have an effect on the milk production and/or the fat content of milk produced by the ruminants. In addition, management of the amount and frequency of feeding of the ruminants may operate to improve milk production and/or the fat content of milk produced by the ruminants. Accordingly, the feed container 100 may include various elements (not shown) configured to regulate the consumption of the dietary supplement disposed within the container body 105. In an embodiment, the one or more openings 115 may include elements to regulate the flow rate, volume, amount, or the like of the dietary supplement exiting the one or more openings 115 as it is being consumed by the ruminant. In another embodiment, the feed container 100 may be associated with elements configured to measure an amount, volume, weight, or the like of the dietary composition consumed by one or more ruminants from the container. In this manner, the feed container 100 may be configured to limit an amount of the dietary composition consumed by one or more ruminants, for example, by closing the openings, generating an alert, or the like responsive to the consumption of a threshold amount of the dietary composition. In an embodiment, a daily threshold amount of consumption of the dietary composition may include about 0.25 kilograms/ruminant, about 0.5 kilograms/ruminant, about 0.75 kilograms/ruminant, about 1 kilogram/ruminant, about 2 kilograms/ruminant, about 5 kilograms/ruminant, about 10 kilograms/ruminant, or values or ranges between any two of the values (including endpoints).

In an embodiment, the feed container 100 may be filled in the pasture or barn where it is located for use by ruminants. In another embodiment, the feed container 100 may be filled at a facility where the feed container is produced and/or in which the dietary composition is prepared and delivered to a pasture or barn for use by ruminants. Milk may be obtained from the ruminants after they have ingested the dietary composition, for instance, according to various milking processes known to those having ordinary skill in the art.

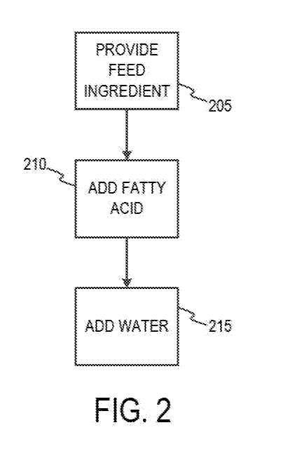

FIG. 2 depicts a flow diagram of a method of preparing a dietary composition for consumption by a ruminant. In various embodiments, the dietary composition may be formulated in a manner so that when consumed by the ruminant, the dietary composition maximizes particular qualities in the milk produced by the ruminant, as well as an amount of milk produced by the ruminant, as described in greater detail herein. In particular embodiments, the dietary composition may be substantially a liquid dietary composition, including, but not limited to, liquid suspensions, non-solids, slurries, emulsions, colloids, and the like.

In various embodiments, the components described herein with respect to FIG. 2 may generally be combined in any order and/or any combination, and are not limited by the order described herein. In some embodiments, a dietary composition may be prepared by providing 205 a feed ingredient, adding 210 a fatty acid to the feed ingredient, and adding 215 water to the feed ingredient and the fatty acid. Thus, processes 205, 210, and 215 result in combining the feed ingredient, the fatty acid, and water to obtain the dietary composition. Processes 205, 210, and 215 may be performed in different orders, or may all be performed simultaneously. Liquid dietary compositions as used herein may include liquids, non-solids, slurries, emulsions, colloids, liquid suspensions, and/or the like. Thus, in various embodiments, the composition may contain water in an amount of about 25% by weight to about 55% of the dietary composition. In particular embodiments, the composition may contain about 25% water by weight, about 30% water by weight, about 35% water by weight, about 40% water by weight, about 45% water by weight, about 50% water by weight, or any value or range between any two of these values (including endpoints). The amount of water present in the composition does not account for any water that may be present in the feed ingredient and/or the fatty acid component. In an embodiment, the dietary composition may be dispersible in at least one organic solvent and/or in water.

In various embodiments, the feed ingredient may be present in the dietary composition in an amount of about 5% to about 45% by weight of the dietary composition. In particular embodiments, the feed ingredient may be present in the dietary composition in an amount of about 5% by weight, about 10% by weight, about 15% by weight, about 20% by weight, about 25% by weight, about 30% by weight, about 35% by weight, about 40% by weight, about 45% by weight, or any value or range between any two of these values (including endpoints).

In various embodiments, the feed ingredient may include at least one nutritive component, including, a carbohydrate, a protein, an amino acid, an amino acid derivative, a vitamin, a trace element, a mineral, a glucogenic precursor, an antioxidant, or any combination thereof. The feed ingredient may include various portions generally included in particular amounts that are sufficient to provide beneficial nutritional and dietary needs of the ruminant that is to consume the dietary composition. For example, the feed ingredient may include a carbohydrate portion and a vitamin portion, each in an amount sufficient to provide beneficial nutritional and dietary needs of the ruminant.

The carbohydrate is not limited by this disclosure and may include any carbohydrates, particularly those used in animal feed. In some embodiments, the carbohydrate may generally provide a source of energy for the feed ingredient. Illustrative examples of carbohydrates may include molasses, sugar beet pulp, sugarcane, wheat bran, oat hulls, grain hulls, soybean hulls, peanut hulls, wood, brewery byproducts, beverage industry byproducts, forages, roughages, silages, molasses, sugars, starches, cellulose, hemicellulose, wheat, corn, oats, sorghum, millet, barley, barley fiber, barley hulls, barley middlings, barley bran, malting barley screenings, malting parley and fines, malt rootlets, maize bran, maize middlings, maize cobs, maize screenings, maize fiber, millet, rice, rice bran, rice middlings, rye, triticale, brewers grain, coffee grinds, tea leaf fines, citrus fruit pulp, rind residues, algae, algae meal, microalgae, and/or the like. In an embodiment, the dietary composition may be sweetened with cane sugar, molasses, and/or the like.

In various embodiments, the glucogenic precursor may include at least one of glycerol, propylene glycol, molasses, propionate, glycerine, propane diol, calcium propionate, propionic acid, octanoic acid, steam-exploded sawdust, steam-exploded wood chips, steam-exploded wheat straw, algae, algae meal, microalgae, or combinations thereof. The glucogenic precursor may generally be included in the feed ingredient to provide an energy source to the ruminant, for example, so as to prevent gluconeogenesis from occurring within the ruminant's body.

The antioxidant is not limited by this disclosure and may include any antioxidants or combination of antioxidants, particularly those used in animal feed and mineral lick compositions. Illustrative examples of antioxidants may include alpha-carotene. beta-carotene, ethoxyquin, butylated hydroxyanisole (BHA), butylated hydroxytoluene (BHT), cryptoxanthin, lutein, lycopene, zeaxanthin, vitamin A, vitamin C, vitamin E, selenium, alpha-lipoic acid, and/or the like.

In various embodiments, the vitamin may include any combination of vitamins including, without limitation, vitamin A, vitamin B, vitamin D, vitamin E, vitamin C, vitamin K, and/or the like. Specific examples of vitamin B include thiamine (vitamin B₁), riboflavin (vitamin B₂), niacin (vitamin B₃), pantothenic acid (vitamin B₅), pyridoxine (vitamin B₆), biotin (vitamin B₇), folic acid (vitamin B₉), cobalamin (vitamin B₁₂), and choline (vitamin Bₚ).

In some embodiments, the feed ingredient may include an amount of carnitine. The carnitine may be included in the feed ingredient to aid in the breakdown of fatty acids to generate metabolic energy in the ruminant. In some embodiments, the carnitine may be present in a premix composition.

In various embodiments, the amino acid may include any combination of common, uncommon, essential, and non-essential amino acids, including, without limitation, essential amino acids such as leucine, lysine, histidine, valine, arginine, threonine, isoleucine, phenylalanine, methionine, tryptophan, and/or any derivative thereof. In some embodiments, the amino acid may be a non-essential amino acid, including any combination of alanine, asparagine, aspartate, cysteine, glutamate, glutamine, glycine, proline, serine, tyrosine, and/or any derivative thereof. The amino acid and/or any derivative thereof may also include amino acids and derivatives of both non-essential and essential amino acids. The amino acid may generally be included in the feed ingredient to provide a nutritional aid in various physiological processes in the ruminant, such as, for example, increasing muscle mass, providing energy, aiding in recovery, and/or the like. In some embodiments, the amino acid may be present in a premix composition.

In various embodiments, the mineral may be any mineral that is a generally recognized as safe (GRAS) mineral or a combination of such minerals. The mineral may further be obtained from any mineral source that provides a bioavailable mineral. In some embodiments, the mineral may be one or more of calcium, sodium, magnesium, potassium, phosphorous, zinc, selenium, manganese, iron, cobalt, copper, iodine, molybdenum, and/or the like. In some embodiments, the mineral may be selected from one or more of a sodium salt, a calcium salt, a magnesium salt, a cobalt salt, a manganese salt, a potassium salt, an iron salt, a zinc salt, copper sulfate, copper oxide, selenium yeast, a chelated mineral, and/or the like. Illustrative examples of sodium salts include monosodium phosphate, sodium acetate, sodium chloride, sodium bicarbonate, disodium phosphate, sodium iodate, sodium iodide, sodium tripolyphosphate, sodium sulfate, sodium selenite, and/or the like. Illustrative examples of calcium salts include calcium acetate, calcium carbonate, calcium chloride, calcium gluconate, calcium hydroxide, calcium iodate, calcium iodobehenate, calcium oxide, anhydrous calcium sulfate, calcium sulfate dehydrate, dicalcium phosphate, monocalcium phosphate, tricalcium phosphate, and/or the like. Illustrative magnesium salts include magnesium acetate, magnesium carbonate, magnesium oxide, magnesium sulfate, and/or the like. Illustrative cobalt salts include cobalt acetate, cobalt carbonate, cobalt chloride, cobalt oxide, cobalt sulfate, and/or the like. Illustrative examples of manganese salts include manganese carbonate, manganese chloride, manganese citrate, manganese gluconate, manganese orthophosphate, manganese oxide, manganese phosphate, manganese sulfate, and/or the like. Illustrative examples of potassium salts include potassium acetate, potassium bicarbonate, potassium carbonate, potassium chloride, potassium iodate, potassium iodide, potassium sulfate, and/or the like. Illustrative examples of iron salts include iron ammonium citrate, iron carbonate, iron chloride, iron gluconate, iron oxide, iron phosphate, iron pyrophosphate, iron sulfate, reduced iron, and/or the like. Illustrative examples of zinc salts include zinc acetate, zinc carbonate, zinc chloride, zinc oxide, zinc sulfate, and/or the like.

In some embodiments, the protein used in the feed ingredient may be obtained from a protein source. Illustrative examples of protein sources may include one or more grains and/or oilseed meals. The grain is generally not limited by this disclosure and may be any edible grain, or combination of grains, that is used as a protein source. Illustrative examples of grains include cereal grains such as barley, millet, wheat, spelt wheat, rye, oats, triticale, rice, corn, buck wheat, quinoa, amaranthus, sorghum, and the like. Oilseed meal is generally derived from residue that remains after reserved oil is removed from oilseeds. The oilseed meal may be rich in protein and variable in residual fats and oils. Illustrative examples of oilseed meal includes rapeseed meal, soybean meal, sunflower meal, cottonseed meal, camelina meal, mustard seed meal, crambe seed meal, safflower meal, rice meal, peanut meal, corn gluten meal, corn gluten feed, distillers dried grains, distillers dried grains with solubles, wheat gluten, and/or the like. According to some embodiments, the feed ingredient may include materials such as algae, microalgae, or the like.

In some embodiments, the feed ingredient may include at least one cellulosic material. The cellulosic material may generally provide a source of fiber for the ruminant to lower cholesterol levels and promote proper digestive function. Illustrative examples of cellulosic materials include wheat bran, wheat middlings, wheat mill run, oat hulls, oat bran, soya hulls, grass meal, hay meal, alfalfa meal, alfalfa, straw, hay, and/or the like.

In various embodiments, the feed ingredient may include a micronutrient mixture. Micronutrient mixtures are not limited by this disclosure and may generally contain any micronutrient mixture now known or later developed. The micronutrient mixture may include various components, such as at least one vitamin and at least one mineral, as described in greater detail herein. In some embodiments, the micronutrient mixture may be present in a premix composition.

In various embodiments, the feed ingredient or portions thereof may be subjected to a grinding process configured to form the feed ingredient or portions thereof into certain particle sizes and/or to achieve a more uniform particle size. In an embodiment, the feed ingredient may be ground before, during and/or after any of processes 205, 210, and 215. For example, a carbohydrate and/or a protein component of the feed ingredient may be ground to a certain particle size. In another example, the feed ingredient itself may be ground to a certain particle size.

Grinding may be performed by various grinding devices known to those having ordinary skill in the art, such as a hammer mill, a roller mill, a disk mill, or the like. The feed ingredient and/or portions thereof may be ground to various sizes, such as particle size (for instance, measured in millimeters), mesh sizes, surface areas, or the like. According to some embodiments, the feed ingredient and/or portions thereof may be ground to a particle size of about 0.05 millimeters, about 1 millimeters, about 2 millimeters, about 5 millimeters, about 7 millimeters, about 10 millimeters, and values or ranges between any two of these values (including endpoints). In some embodiments, the various components may be ground so that about 20% to 50% of the each component and/or all components are retained by a mesh having openings with a size of about 10 mm and so that about 70% to about 90% of each component and/or all components are retained by a mesh having openings with a size of about 1 mm. In some embodiments, the various components may have a varying distribution of particle sizes based upon the ingredients. For example, in embodiments containing one or more wheat ingredients, the particle size may be distributed so that about 95% of the ground wheat ingredients are retained by a mesh having openings with a size of about 0.0625 mm and so that about 65% of the ground wheat ingredients are retained by a mesh having openings with a size of about 1.0 mm. In another example, such as embodiments containing one or more barley ingredients, the particle size may be distributed so that about 95% of the ground barley ingredients are retained by a mesh having openings with a size of about 0.0625 mm and so that about 60% of the ground barley ingredients are retained by a mesh having openings with a size of about 1.0 mm. The varying mesh sizes of each ingredient may be independent of mesh sizes for other ingredients.

Grinding may provide various benefits, such as improving certain characteristics of the feed ingredient and/or the dietary composition formed therefrom. For instance, even and fine particle size may improve the mixing of different ingredients. According to certain embodiments, grinding may be configured to decrease a particle size of certain components of the dietary composition, for example, to increase the surface area open for enzymes in the gastrointestinal tract, which may improve the digestibility of nutrients, and/or to increase the palatability of the feed.

In various embodiments, the fatty acid component may generally include one or more free fatty acids and/or glycolipids. Free fatty acids may generally be unconjugated fatty acids, whereas glycolipids may be fatty acids conjugated with a carbohydrate. In some embodiments, the fatty acid component may be present in the dietary composition in an amount of at least about 30% by weight to about 80% by weight of the dietary composition. In particular embodiments, the fatty acid component may be present in the dietary composition in an amount of about 30% by weight, about 35% by weight, about 40% by weight, about 45% by weight, about 50% by weight, or any value or range between any two of these values. In some embodiments, the fatty acid component may represent about 30% to about 50% by weight of the dietary composition.

In some embodiments, the fatty acid component may have a melting point equal to or greater than about 40° C. In some embodiments, the fatty acid component may have a melting point equal to or less than about 80° C. In some embodiments, the fatty acid component may have a melting point of about 40° C. to about 80° C. In particular embodiments, the fatty acid component may have a melting point of about 40° C., about 45° C., about 50° C., about 55° C., about 60° C., about 65° C., about 70° C., about 75° C., about 80° C., or any value or range between any two of these values (including endpoints). The melting point may be selected so that it is a temperature that aids in keeping the fatty acid inert in the rumen environment. In one embodiment, the fatty acid has a melting point that is less than the temperature of the rumen environment.

In various embodiments, the fatty acid component may include at least one saturated fatty acid and/or saturated fatty acid compound. For example, the fatty acid compound may include 1, 2, 3, 4, 5, 6, or more different saturated fatty acids. In some embodiments, the saturated fatty acid may be present in the fatty acid component in an amount that results in a ruminant consuming the dietary composition to produce a desired quality and quantity of milk, as described in greater detail herein. Thus, in some embodiments, the saturated fatty acid may be present in an amount of about 90% by weight of the fatty acid component to about 100% by weight of the fatty acid component, including about 90% by weight, about 91% by weight, about 92% by weight, about 93% by weight, about 94% by weight, about 95% by weight, about 96% by weight, about 97% by weight, about 98% by weight, about 99% by weight, about 100% by weight, or any value or range between any two of these values. In an embodiment, the fatty acid component may be 100% of the saturated fatty acid component, in other words, the fatty acid component is saturated fatty acid.

The saturated fatty acid is not limited by this disclosure, and may include any number of saturated fatty acids now known or later discovered, including all derivatives thereof. For example, derivatives of a saturated fatty acid may include salts, esters, amides, carbonates, carbamates, imides, anhydrides, alcohols, and/or the like.

As used herein, the term “salt” of the fatty acid may be any acid addition salt, including, but not limited to, halogenic acid salts such as, for example, hydrobromic, hydrochloric, hydrofluoric, and hydroiodic acid salt; an inorganic acid salt such as, for example, nitric, perchloric, sulfuric, and phosphoric acid salt; an organic acid salt such as, for example, sulfonic acid salts (methanesulfonic, trifluoromethane sulfonic, ethanesulfonic, benzenesulfonic, or p-toluenesulfonic), acetic, malic, fumaric, succinic, citric, benzoic, gluconic, lactic, mandelic, mucic, pamoic, pantothenic, oxalic, and maleic acid salts; and an amino acid salt such as aspartic or glutamic acid salt. The acid addition salt may be a mono- or di-acid addition salt, such as a di-hydrohalogenic, di-sulfuric, di-phosphoric, or di-organic acid salt. In all cases, the acid addition salt is used as an achiral reagent which is not selected on the basis of any expected or known preference for interaction with or precipitation of a specific optical isomer of the products of this disclosure.

As used herein, a fatty acid ester means an ester of a fatty acid. For example, the fatty acid ester may be in a form of RCOOR′. R may be any saturated or unsaturated alkyl group including, without limitation, C10, C12, C14, C16, C18, C20, and C24. R′ may be any group having from about 1 to about 1000 carbon atoms and with or without hetero atoms. In some embodiments, R′ may have from about 1 to about 20, from about 3 to about 10, and from about 5 to about 15 carbon atoms. The hetero atoms may include, without limitation, N, O, S, P, Se, halogen, Si, and B. For example, R′ may be a C₁₋₆alkyl, such as methyl, ethyl or t-butyl; a C₁₋₆alkoxyC₁₋₆alkyl; a heterocyclyl, such as tetrahydrofuranyl; a C₆₋₁₀aryloxyC₁₋₆alkyl, such as benzyloxymethyl (BOM); a silyl, such as trimethylsilyl, t-butyldimethylsilyl and t-butyldiphenylsilyl; a cinnamyl; an allyl; a C₁₋₆alkyl which is mono-, di- or trisubstituted by halogen, silyl, cyano or C₁₋₆aryl, wherein the aryl ring is unsubstituted or substituted by one, two or three, residues selected from the group consisting of C₁₋₇alkyl, C₁₋₇alkoxy, halogen, nitro, cyano and CF₃; or a C₁₋₂alkyl substituted by 9-fluorenyl.

As used herein, an amide of the fatty acid may generally include amides of fatty acids where the fatty acid is bonded to an amide group. For example, the fatty acid amide may have a formula of RCONR′R″. R may be any saturated or unsaturated alkyl group including, without limitation, C10, C12, C14, C16, C18, C20, and C24. R′ and R″ may be any group having from about 1 to about 1000 carbon atoms and with or without hetero atoms. In some embodiments, R′ may have from about 1 to about 20, from about 3 to about 10, and from about 5 to about 15 carbon atoms. The hetero atoms may include, without limitation, N, O, S, P, Se, halogen, Si, and B. For example, R′ and R″ each may be an alkyl, an alkenyl, an alkynyl, an aryl, an aralkyl, a cycloalkyl, a halogenated alkyl, or a heterocycloalkyl group.

An anhydride of the fatty acid may generally refer to a compound which results from the condensation of a fatty acid with a carboxylic acid. Illustrative examples of carboxylic acids that may be used to form a fatty acid anhydride include acetic acid, propionic acid, benzoic acid, and the like.

An alcohol of a fatty acid may generally refer to a fatty acid having straight or branched, saturated, radical groups with 3-30 carbon atoms and one or more hydroxy groups. The alkyl portion of the alcohol component can be propyl, butyl, pentyl, hexyl, iso-propyl, iso-butyl, sec-butyl, tert-butyl, or the like. One of skill in the art may appreciate that other alcohol groups may also useful in the present disclosure.

In some embodiments, the saturated fatty acid may include a palmitic acid compound. The palmitic acid compound is not limited by this disclosure, and may include one or more of a conjugated palmitic acid, unconjugated palmitic acid, free palmitic acid, palmitic acid derivatives, and/or the like. Palmitic acid, also known as hexadecanoic acid, has a molecular formula of CH₃(CH₂)₁₄CO₂H. Specific examples of palmitic acid derivatives may include palmitic acid esters, palmitic acid amides, palmitic acid salts, palmitic acid carbonates, palmitic acid carbamates, palmitic acid imides, palmitic acid anhydrides, and/or the like. The palmitic acid compound may be present in the fatty acid component in an amount of about 60% by weight of the fatty acid to about 100% by weight of the fatty acid, including about 60% by weight, about 65% by weight, about 70% by weight, about 75% by weight, about 80% by weight, about 85% by weight, about 90% by weight, about 95% by weight, about 98% by weight, about 99% by weight, about 100% by weight, or any value or range between any two of these values (including endpoints). In some embodiments, the fatty acid component may consist essentially of the palmitic acid compound. In other embodiments, the fatty acid component may be composed entirely of the palmitic acid compound.

In some embodiments, the saturated fatty acid may include a stearic acid compound. The stearic acid compound is not limited by this disclosure, and may include conjugated stearic acid, unconjugated stearic acid, free stearic acid, stearic acid derivatives, and/or the like. Stearic acid, also known as octadecanoic acid, has a chemical formula of CH₃(CH₂)₁₆CO₂H. Specific examples of stearic acid derivatives may include stearic acid esters, stearic acid amides, stearic acid salts, stearic acid carbonates, stearic acid carbamates, stearic acid imides, stearic acid anhydrides, and/or the like. Because stearic acid in large amounts may hinder milk production capacity of the mammary gland, the amount of stearic acid may be present in the fatty acid component in an amount of about 30% or less by weight of the fatty acid component. In particular embodiments, the stearic acid compound may include about 30% by weight of the fatty acid component, about 25% by weight of the fatty acid component, about 20% by weight of the fatty acid component, about 15% by weight of the fatty acid component, about 10% by weight of the fatty acid component, about 5% by weight of the fatty acid component, or any value or range between any two of these values. In particular embodiments, the palmitic acid compound and the stearic acid compound have a molar ratio of about 2:1, about 5:1, about 10:1, or values or ranges between any two of these values (including endpoints).

In some embodiments, the fatty acid component may include an unsaturated fatty acid. The term “unsaturated fatty acid” as used herein refers to any mono- and polyunsaturated fat, and includes unsaturated trans fatty acids. The unsaturated fatty acids must contain at least one alkene bond and may contain two or more alkene groups in any position in the hydrocarbon chain, and the unsaturation may or may not be present as a conjugated system of double bonds. The unsaturated fatty acid is not limited by this disclosure, and may include any number of unsaturated fatty acids now known or later discovered, including all derivatives thereof. For example, derivatives of an unsaturated fatty acid may include salts, esters, amides, anhydrides, alcohols, and/or the like, as previously described herein. In various embodiments, a minimal amount of unsaturated fatty acid in the fatty acid component to affect a desired quality of milk produced by the ruminant consuming the dietary composition may be used, as described in greater detail herein. Thus, in some embodiments, the fatty acid component may be substantially free of unsaturated fatty acids. As used herein with respect to unsaturated fatty acids, the term “substantially free” is understood to mean substantially no amount of unsaturated fatty acids or about 10% or less by weight of unsaturated fatty acids, including trace amounts of unsaturated fatty acids. Accordingly, the unsaturated fatty acid may be present in the fatty acid component in an amount of about 10% or less by weight of the fatty acid component, including about 10% or less by weight, about 5% or less by weight, about 4% or less by weight, about 3% or less by weight, about 2% or less by weight, about 1% or less by weight, about 0.5% or less by weight, about 0% by weight, or any value or range between any two of these values.

In various embodiments, at least a portion of the fatty acid component may be wholly or partially contained within another structure or material. In some embodiments, the fatty acid may be pre-contained prior to adding 210 the fatty acid to the feed ingredient. In other embodiments, the fatty acid may be contained as a result of the various processes 205, 210, 215 described herein. In some embodiments, the fatty acid may generally be contained by at least one supermolecular structure. Supermolecular structures may include vesicular structures such as microemulsions, liposomes (vesicles), micelles, and reverse micelles. The liposomes (vesicles) may contain an aqueous volume that is entirely enclosed by a membrane composed of lipid molecules, such as phospholipids. In some embodiments, the liposomes may have a bilayer membrane. In some embodiments, the liposomes may include at least one surfactant. Examples of surfactants may include polyoxyethylene ethers and esters of fatty acids. The surfactant may have an hydrophilic-lipophilic balance (HLB) value of about 2 to about 12, including about 2, about 3, about 4, about 5, about 6, about 7, about 8, about 9, about 10, about 11, about 12, or any range or value between any two of these values. Micelles and reverse micelles are microscopic vesicles that contain amphipathic constituents but do not contain an aqueous volume that is entirely enclosed by a membrane. In micelles, the hydrophilic part of the amphipathic compound is on the outside (on the surface of the vesicle). In reverse micelles, the hydrophobic part of the amphipathic compound is on the outside. The reverse micelles may thus contain a polar core that can solubilize both water and macromolecules within the inverse micelle. As the volume of the core aqueous pool increases, the aqueous environment begins to match the physical and chemical characteristics of bulk water. The resulting inverse micelle may be referred to as a microemulsion of water in oil.

In some embodiments, at least a portion of the fatty acid may be contained in a core of a micelle or a vesicle. The core may include any number of particles therein in addition to the fatty acid. The core composition may be made of a core material that includes at least one of the protein material, the cellulosic material, the amino acid, and the amino acid derivative, as described in greater detail herein.

In various embodiments, at least a portion of the fatty acid component may be encapsulated. In some embodiments, the fatty acid may be pre-encapsulated prior to adding 210 the fatty acid to the feed ingredient. In other embodiments, the fatty acid may be encapsulated as a result of the various processes 205, 210, 215 described herein. In some embodiments, the fatty acid may generally be encapsulated by a capsule. The capsule may include a capsule shell, which is made up of polysaccharide or protein. Illustrative examples of capsule shells as described herein may include capsule shells including agar, gelatin, starch casein, chitosan, soya bean protein, safflower protein, alginates, gellan gum, carrageenan, xanthan gum, phthalated gelatin, succinated gelatin, cellulosephthalate-acetate, polyvinylacetate, hydroxypropyl methylcellulose, polyvinylacetate-phthalate, polymerisates of acrylic esters, polymerisates of methacrylic esters, and/or mixtures thereof

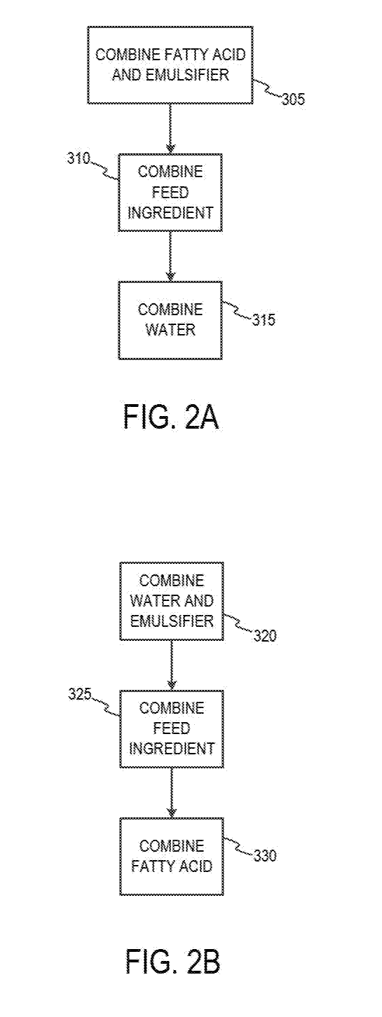

In various embodiments, an emulsifier or emulsifying agent may be combined with the feed ingredient, the fatty acid component and the water to form an emulsion, as depicted in FIGS. 3A and 3B. In an embodiment, the emulsifier may be cationic, anionic, or non-ionic. As depicted in FIG. 3A, the fatty acid may be combined 305 with the emulsifier to provide an emulsion. The combination 305 may include combining the fatty acid and the emulsifier under pressure. Suitable pressures may include about 1 atmosphere to about 10 atmospheres. The emulsion may be combined 310 with the feed ingredient and combined 315 with the water to obtain the final product.

The emulsifier is not limited by this disclosure, and may generally be any composition that is capable of emulsifying the dietary composition. Specific examples of emulsifiers may include lecithin, natural seed weed, natural seed gums, natural plant exudates, natural fruit extracts, animal skin and bone extracts, bio-synthetic gums, starches, fibers, sucrose esters, Tween, polyglycerol esters, sugar esters, castor oil, and ethoxylated castor oil. Examples of natural seed weed may include carrageenan, alginates, agar, agarose, fucellan, and xanthan gum or a combination thereof. Examples of natural seed gums may include guar gum, locust bean gum, tara gum, tamarind gum, and psillium gum. Examples of natural plant exudates are gum Arabic, tragacanth, karaya, and ghatti. Natural fruit extracts are, for example, low and high methoxyl pectins. Animal skin and bone extracts are, for example, gelatin A, gelatin B, and hydrolyzed gelatin. Gum Arabic is a natural food additive obtained from certain varieties of acacia. It is generally tasteless and odorless, and may be used in commercial food processing to thicken, emulsify, and/or stabilize foods. Guar gum is a gummy substance obtained from plants of the legume genera. Guar gum may also be used as a thickener and/or a stabilizer in commercial food processing. Xanthan gum is produced by fermentation of corn sugar, and may be used as a thickener, an emulsifier, and/or a stabilizer of foods. In particular embodiments, gum Arabic, guar gum, xanthan gum, and/or pectin may be used in combination as an emulsion stabilizer. Illustrative examples of bio-synthetic gums may include xanthan, gellan, curdian, and pullulan. Examples of starches may include natural starch, chemically modified starch, physically modified starch, and enzymatically modified starch. Castor oil may be effective as an emulsifier because of its ability to render oil soluble in water.

In various embodiments, the emulsifier may have a hydrophilic-lipophilic balance (HLB) of about 5 to about 14. In particular embodiments, the HLB of the emulsifier may be about 5, about 6, about 7, about 8, about 9, about 10, about 11, about 12, about 13, about 14, or any value or range between any two of these values (including endpoints).

In various embodiments, the emulsifier may be present in the dietary composition in an amount of about 0.01% by weight to about 2.0% by weight of the dietary composition. In particular embodiments, the emulsifier may be present in the dietary composition in an amount of about 0.01% by weight, about 0.05% by weight, about 0.1% by weight, about 0.2% by weight, about 0.25% by weight, about 0.3% by weight, about 0.5% by weight, about 0.6% by weight, about 0.75% by weight, about 1.0% by weight, about 1.25% by weight, about 1.5% by weight, about 1.75% by weight, about 2.0% by weight, or any value or range between any two of these values (including endpoints).

In some embodiments, such as the embodiment depicted in FIG. 2B, the emulsifier may be combined 320 with water under pressure to provide an emulsion. Suitable pressures may include about 1 atmosphere to about 10 atmospheres. The emulsion may be combined 325 with the feed ingredient and combined 330 with the fatty acid to obtain the final product.

In various embodiments, a method of increasing milk fat content in ruminants may include providing the dietary composition as described herein to the ruminant for ingestion. In some embodiments, the dietary composition may be provided as a supplement. In particular embodiments, the dietary composition may be a liquid dietary composition, as described in greater detail herein. In one embodiment, the dietary composition may be fed to the ruminant by use of a lick tank. In some embodiments, the composition may be combined with feed to be provided to the ruminant. In some embodiments, the composition may be coated on the feed to be provided to the ruminant. In some embodiments, the dietary composition may be provided to the ruminant in an amount that the ruminant receives at least about 10 grams of fatty acid per kilogram of milk produced by the ruminant each day. The amount may be based on the previous day's milk production by the ruminant, an average day based on the previous week's milk production by the ruminant, an average day based on the previous month's milk production by the ruminant, an average production of milk by the ruminant when not provided the dietary composition, and/or the like. In some embodiments, the ruminant may be provided with additional amounts of the dietary composition to make up for portions of the dietary composition that are not consumed by the ruminant such as amounts that are spilled by the ruminant when consuming the dietary composition and/or the like.

In some embodiments, providing the dietary composition to the ruminant for the ruminant to consume may result in an increase in production of milk and/or an increase in fat content of the milk produced. These increases may generally be relative to a similar ruminant that does not receive the dietary composition, an average of similar ruminants not receiving the dietary composition, an average of the milk production quantity and fat content of the same ruminant when not provided the dietary composition, and/or the like. In particular embodiments, the milk production may increase by an amount of about 1% to about 10%, including about 1%, about 2%, about 3%, about 4%, about 5%, about 6%, about 7%, about 8%, about 9%, about 10%, or any value or range between any two of these values. In particular embodiments, the milk fat content may increase by an amount of about 10% to about 15%, including about 10%, about 11%, about 12%, about 13%, about 14%, about 15%, or any value or range between any two of these values (including endpoints) as compared to the fat content of milk produced by dairy cows that do not ingest the ruminant feed product according to the methods described herein.

### EXAMPLES

### Example 1

### Lick Tank for Dispensing Dietary Composition

A liquid dietary composition to be fed to dairy cows is made using a process of combining a feed ingredient, a fatty acid, and water. The fatty acid component is combined in an amount that is about 60% by weight of the liquid dietary composition. The fatty acid component includes about 98% by weight of free palmitic acid, about 2% by weight of stearic acid, and no unsaturated trans fatty acids. A melting point of the fatty acid component is about 60° C.

The liquid dietary composition includes about 10% by weight of a feed ingredient. The feed ingredient includes wheat bran, grain hulls, soybean hulls, leucine, arginine, calcium, magnesium, vitamin A, vitamin D, and glycerine. The feed ingredient is ground to an average particle size of about 2 millimeters using a roller mill. The liquid dietary composition also includes about 30% of water by weight.

The liquid dietary composition is dispensed to the dairy cows using a 100 liter lick tank. The lick tank includes a volume meter configured to determine an amount of the liquid dietary composition removed (consumed) from the lick tank by the dairy cows. The lick tank is configured to close the openings used by the dairy cows to access the liquid composition responsive to a threshold volume of consumption of the liquid composition of about 1 kilogram/ruminant.

The dairy cows produce about 7% more milk containing about 5% more milk fat content than when on a diet that did not include the liquid dietary composition fed using the lick tank.

### Example 2

### Trough for Dispensing Dietary Composition

A trough configured to hold up to about 80 liters of a liquid dietary composition is located in a fenced-in pasture on a farm holding 30 ruminants. The liquid dietary composition is provided as a dietary supplement to the nutrition the ruminants receive from eating within the pasture and from primary feed sources provided by the operator of the farm. The trough is in liquid communication with a storage container such that the volume of the liquid dietary composition removed from the trough will be replaced with the liquid dietary composition in the storage container to maintain the volume of the liquid dietary composition in the trough at about 80 liters.

The liquid dietary composition is made using a process of combining a feed ingredient, a fatty acid, and water. The fatty acid component is combined in an amount that is about 45% by weight of the liquid dietary composition. The fatty acid component includes about 92% by weight of free palmitic acid and has a melting point of about 75° C. The liquid dietary composition includes about 30% water by weight and about 20% by weight of a feed ingredient. The feed ingredient includes sugar cane, oat hulls, grain hulls, cellulose, sorghum, millet, a lysine derivative, a trace amount of zinc, vitamin E, and vitamin B₁.

The liquid dietary composition is dispensed to the dairy cows using a 100 liter lick tank. The lick tank includes a volume meter configured to determine an amount of the liquid dietary composition removed (consumed) from the lick tank by the dairy cows. The lick tank is configured to close the openings used by the dairy cows to access the liquid composition responsive to a threshold volume of consumption of the liquid composition of about 1 kilogram/ruminant.

### Example 3

### Two-Month Study Confirms Efficacy of Liquid Dietary Composition

An experiment is performed where conventional complete feed is replaced with a liquid dietary composition according to the present disclosure. The experiment is conducted for two months. The liquid dietary composition includes the following ingredients and amounts (in percent by total weight of the liquid dietary composition).

| | |
|---|---|
| Water | 25 |
| Sugar beet pulp | 8 |
| Barley | 12 |
| Palmitic Acid | 11 |
| Wheat bran | 9 |
| Soybean hulls | 7 |
| Propylene glycol | 5 |
| Molasses | 20 |
| Sodium bicarbonate | 2 |
| Biotin | 0.5 |
| Carnitine | 0.2 |
| Methionine | 0.25 |
| Emulsifier (non-ionic) | 0.05 |

The ingredients described above are mixed by placing the water in a container and adding the remaining ingredients substantially simultaneously. The mixture may be stirred to ensure the ingredients are well-blended. Upon feeding the test feed mixture to a cow, the following results are obtained from milk produced by the cow, where “Reference” refers to milk obtained from a similarly treated cow not fed the liquid dietary composition in a container.

| | Reference | Test Feed |
|---|---|---|
| Milk (kg/d) | 29.5 | 32.5 |
| Fat % by weight | 3.98 | 4.43 |

As shown in the expected results above, milk fat concentrations and the amount of milk produced increase significantly.

### Example 4

### Supplemental Use of Liquid Dietary Feed in a Container Improves Milk Volume and Fat Content

An experiment is performed where conventional complete feed is supplemented with a liquid dietary composition according to the present disclosure. The dietary composition has a fatty acid composition as described herein with respect to Example 3. The experiment is conducted for two months. The liquid dietary composition includes the following ingredients and amounts (in percent by total weight of the liquid dietary composition).

| | |
|---|---|
| Water | 28 |
| Rapeseed meal | 16 |
| Barley | 17 |
| Wheat | 12 |
| Sugar beet pulp | 5.3 |
| Mixed molasses | 15 |
| Mineral mixture | 3 |
| Micronutrient mixture | 0.1 |
| vitamin mixture | 0.1 |
| Emulsifier | 0.05 |
| Fatty Acid Component | 3.0 |

The fatty acid mixture and the emulsifier are mixed into the other materials to obtain 100% by weight of feed mixture. The feed mixture is mixed in a horizontal mixer for 3 minutes, and the emulsifier and fatty acid mixture are melted into the other materials in a long-term conditioner for 20 minutes at a temperature of 77° C. in order to slowly melt and mix the materials together. Dairy cows are given the mixture in an amount of about 6-16 kg per day over the course of 2 months. The following results are obtained from milk produced by the cow, where “Reference” refers to milk obtained from a similarly treated cow not fed the liquid dietary composition in a container:

| | Reference | Test Feed |
|---|---|---|
| Milk (kg/d) | 30.0 | 33.5 |
| Fat % by weight | 4.16 | 4.53 |

As shown in the expected results above, milk fat concentrations and the amount of milk produced increase significantly.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera As a non-limiting example, each range discussed herein can be readily broken down into a lower third, middle third and upper third, et cetera As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A feeding container having a dietary composition disposed therein, the dietary composition comprising at least one saturated fatty acid compound and at least one carrier component including water or a suspension in water.

2. The feeding container of claim 1, wherein the feeding container is a lick tank, a stock tank, a watering tank, a trough, a bucket, or a pail.

3. The feeding container of claim 1, wherein the dietary composition further comprises a sweetener selected from the group consisting of cane sugar and molasses.

4. The feeding container of claim 1, wherein the container is a 61 liter container, a 189 liter container, a 473 liter container, or a 946 liter container.

5. The feeding container of claim 1, wherein the dietary composition contains less than about 5% by weight of a trans-fatty acid compound.

6. (canceled)

7. The feeding container of claim 1, wherein the dietary composition contains substantially no trans-fatty acid compound.

8. The feeding container of claim 1, wherein the at least one saturated fatty acid compound is a palmitic acid compound selected from the group consisting of palmitic acid, a palmitate salt, a palmitate ester, a palmitate amide and a palmitate anhydride.

9.-10. (canceled)

11. The feeding container of claim 1, wherein the at least one saturated fatty acid compound is a stearic acid compound selected from the group consisting of stearic acid, a stearate salt, a stearate ester, a stearate amide and a stearate anhydride.

12.-14. (canceled)

15. The feeding container of claim 1, wherein:
the at least one saturated fatty acid compound comprises a first saturated fatty acid compound and a second saturated fatty acid compound;
the first saturated fatty acid compound is a palmitic acid compound; and
the second saturated fatty acid compound is a stearic acid compound.

16.-17. (canceled)

18. The feeding container of claim 1, wherein the at least one saturated fatty acid compound is present in the dietary composition at a concentration of at least about 50% by weight.

19. The feeding container of claim 1, wherein the at least one saturated fatty acid compound is present in the dietary composition at a concentration of at least about 90% by weight.

20. The feeding container of claim 1, wherein the at least one saturated fatty acid compound is a palmitic acid compound and is present in the dietary composition at a concentration of at least about 10% by weight.

21. The feeding container of claim 1, wherein the at least one saturated fatty acid compound is a stearic acid compound and is present in the dietary composition at a concentration of about 30% by weight or less.

22. The feeding container of claim 1, wherein:
the at least one saturated fatty acid compound is palmitic acid and is present in the dietary composition at a concentration of at least about 30% by weight; and
the dietary composition is substantially free of a trans-fatty acid.

23. The feeding container of claim 1, wherein:
the at least one saturated fatty acid compound comprises a first saturated fatty acid compound and a second saturated fatty acid compound;
the first saturated fatty acid compound is a palmitic acid compound and is present in the dietary composition at a concentration of at least about 10% by weight; and
the second saturated fatty acid compound is a stearic acid compound and is present in the dietary composition at a concentration of about 30% by weight or less.

24.-28. (canceled)

29. The feeding container of claim 1, further comprising a nutritive component selected from the group consisting of a protein, an amino acid, a vitamin, a mineral, an antioxidant, a lipid, a glycolipid, a polysaccharide, a carbohydrate and a glucogenic precursor.

30.-33. (canceled)

34. The feeding container of claim, further comprising a nutritive component selected from the group consisting of calcium acetate, calcium carbonate, calcium chloride, calcium gluconate, calcium hydroxide, calcium iodate, calcium iodobehenate, calcium oxide, calcium sulfate anhydrous, calcium sulfate dihydrate, cobalt acetate, cobalt carbonate, cobalt chloride, cobalt oxide, cobalt sulfate, dicalcium phosphate, magnesium acetate, magnesium carbonate, magnesium oxide, magnesium sulfate, manganese carbonate, manganese chloride, manganese citrate, manganese gluconate, manganese orthophosphate, manganese oxide, manganese phosphate dibasic, manganese sulfate, monocalcium phosphate, monosodium phosphate, potassium acetate, potassium bicarbonate, potassium carbonate, potassium chloride, potassium iodate, potassium iodide, potassium sulfate, sodium acetate, sodium chloride, sodium bicarbonate, disodium phosphate, iron ammonium citrate, iron carbonate, iron chloride, iron gluconate, iron oxide, iron phosphate, iron pyrophosphate, iron sulfate, reduced iron, sodium iodate, sodium iodide, sodium tripolyphosphate, sodium sulfate, tricalcium phosphate, zinc acetate, zinc carbonate, zinc chloride, zinc oxide and zinc sulfate.

35. (canceled)

36. The feeding container of claim 1, wherein the dietary composition further comprises at least one emulsifying agent.

37. The feeding container of claim 36, wherein the at least one emulsifying agent is cationic, anionic, or non-ionic.

38. (canceled)

39. The feeding container of claim 36, wherein the at least one emulsifying agent is selected from the group consisting of sorbitan esters, polyoxyethylene derivatives of sorbitan esters, glyceryl esters, methylcellulose, carboxymethylcellulose, acacia, tragacanth, agar, pectin, carrageenan and lecithin, gelatin.

40.-41. (canceled)

42. The feeding container of claim 1, wherein the dietary composition further comprises at least one emulsifying agent present in the composition at a concentration of about 0.2% by weight to about 1.5% by weight.

43.-44. (canceled)

45. The feeding container of claim 1, wherein the dietary composition further comprises at least one emulsifying agent having a hydrophobic-lipophilic balance of about 5 to about 14.

46. (canceled)

47. The feeding container of claim 1, wherein the dietary composition further comprises at least one emulsifying agent selected from the group consisting of lecithin, polyoxyethylene stearate, polyoxyethylene sorbitan monolaurate, polyoxyethylene sorbitan, polyoxyethylene, sorbitan monopalmitate, polyoxyethylene sorbitan monostearate, polyoxyethylene sorbitan tristearate, ammonium phosphatides, salts of fatty acids, glycerides of fatty acids, acetic acid esters of glycerides of fatty acids, lactic acid esters of glycerides of fatty acids, citric acid esters of fatty acids, acetyl tartaric acid esters of fatty acids, sucrose esters of fatty acids, sucroglycerides, polyglycerol esters of fatty acid, polyglycerol polyricinoleate, propane-1,2-diol esters of fatty acids, oxidized soya bean oil glycerides, castor oil glycerides, sodium stearoyl-2-lactylate, calcium stearoyl-2-lactylate, sorbitan monostearate, sorbitan tristearate, sorbitan monolaurate, sorbitan monooleate and sorbitan monopalmitate.

48.-54. (canceled)

55. A method of preparing a containerized dietary composition, the method comprising:
providing a dietary composition comprising at least one saturated fatty acid compound and at least one carrier component including water or a suspension in water; and
disposing the dietary composition in a feed container to form a containerized dietary composition.

56. The method of claim 55, wherein the providing step comprises contacting the at least one saturated fatty acid compound and the at least one carrier component to form the dietary composition.

57. The method of claim 55, wherein the feed container is a lick tank, a stock tank, a watering tank, a trough, a bucket, or a pail.

58. A method of preparing a containerized dietary composition, the method comprising:
dispersing at least one saturated fatty acid compound in water to form a colloid;
combining the colloid and at least one carrier component to form a dietary composition; and
disposing the dietary composition in a feed container to form a containerized dietary composition.

59. The method of claim 58, wherein the feed container is a lick tank, a stock tank, a watering tank, a trough, a bucket, or a pail.
